(19) United States
(12) Patent Application Publication
(10) Pub. No.: US 2010/0081480 A1
(43) Pub. Date: Apr. 1, 2010

(54) MOBILE APPARATUS, AND CALLING METHOD OF MOBILE APPARATUS

(75) Inventors: Yue Zhang, Tokyo (JP); Akemi Toyokura, Tokyo (JP); Takushiro Haneda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/404,543

(22) Filed: Mar. 16, 2009

(30) Foreign Application Priority Data
Sep. 30, 2008 (JP) 2008-254631

(51) Int. Cl. H04M 1/00

(52) U.S. Cl. 455/567

(57) ABSTRACT

In an mobile apparatus, which has a transmission unit for transmitting contents including at least melody data to a communication terminal for reproducing the contents as an incoming melody and in which a user can find a file transfer state and the like from the sense of hearing without paying attention to a screen in such a manner that the progress of a file being transferred and a result of transfer of the file are indicated by the audio effect, the mobile apparatus has a first sounding unit for sounding sound effect while the contents are being transferred, a second sounding unit for sounding, when transmission of the contents is finished, sound effect indicating whether the transmission is succeeded or fails, and a calling unit for calling an opponent to which the contents are transmitted based on the completion of transmission of the contents.

### BACKGROUND OF THE INVENTION

1. Field of the Invention

The present invention relates to a mobile apparatus which has a function for transmitting contents including at least melody data to a communication apparatus for reproducing the contents as an incoming melody and which permits a user to confirm a progress of the transmission by his or her ear.

2. Description of the Related Art

In an ordinary mobile apparatus such as a mobile phone and the like, an incoming side mobile apparatus has such a function that when it receives an incoming call, it notifies a user of an outgoing side mobile apparatus, from which the incoming call is transmitted, of the incoming call by reproducing an incoming melody previously set by a user of the incoming side mobile apparatus. For example, Japanese Unexamined Patent Application Publication No. 2006-148527 discloses a mobile phone in which a user can securely find whether an incoming call is received or not while using an incoming melody which the user likes. When the mobile phone receives an incoming call, it reads out an incoming melody from ROM, determines whether the volume of the incoming melody is small or not by an envelope detection unit, and when the mobile phone determines that the volume is small, it increases the degree of amplification of VCA referring to LUT.

In contrast, recently, the number of mobile phone is increased which has such a function that an outgoing side mobile phone transmits multimedia contents to an incoming side mobile phone as incoming contents and the incoming side mobile phone receives the incoming contents and reproduces them in place of an existing incoming melody. The mobile phone has a problem in that a time zone occurs during which a transmission side user must wait until transfer of a file is completed before voice communication processing is started different from an ordinary voice communication.

At present, although a progress bar and a pop-up screen are displayed on a display to show the progress of a file transfer during the waiting time of the user, the user must keep a state in which the he or she holds the mobile phone in front of his or her face in place of a state in which the user puts his or her ear on the mobile phone to confirm the display. Since a time of 30 seconds or longer may be required in the worst case although the time is different depending on a file size and a communication status in order to transfer the file, it imposes a burden to the user that the user visually confirms the process in which the file is transferred during the above time. Further, since a waiting operation while the file is being transferred is different from a practice of a voice communication in which a user waits for start of communication with a mobile phone put on his or her ear after the he or she operates a dial, there is a possibility that the user feels inconvenient when he or she uses the function for the first time.

An object of the present invention, which was made in view of the above problem, is to provide a mobile apparatus which has a function for transmitting contents including at least melody data to a communication terminal for reproducing the contents as an incoming melody and in which a user can find a file transfer state and the like from the sense of hearing without paying attention to a screen by indicating a progress of file transfer and a result of file transfer by sound effect while a file is being transferred.

### SUMMARY OF THE INVENTION

To solve the above problem, in a mobile apparatus according to the present invention having transmission unit for transmitting contents including at least melody data to a communication terminal for reproducing the contents as an incoming melody, the mobile apparatus has a first sounding unit for sounding sound effect while the contents are being transmitted by the transmission unit, a second sounding unit for sounding, when transmission of the contents by the transmission unit is finished, sound effect indicating whether the transmission is succeed or fails, a transmission unit for executing transmission to an opponent to which the contents are transmitted based on the completion of transmission of the contents by the transmission unit.

And, in a calling method of a mobile apparatus according to the present invention having a transmission unit configured to transmit contents including at least melody data to a communication terminal for reproducing the contents as an incoming melody comprising, a first sounding step of sounding sound effect while the contents are being transmitted by the transmission unit, a second sounding step of sounding, when transmission of the contents by the transmission unit is finished, sound effect indicating whether the transmission is succeeded or fails, and a calling step of calling an opponent to which the contents are transmitted based on the completion of transmission of the contents by the transmission unit.

The mobile apparatus of the present invention has a function has a function for transmitting contents including at least melody data to a communication terminal for reproducing the contents as an incoming melody and in which a user can find a file transfer state and the like from the sense of hearing without paying attention to a screen by indicating a progress of file transfer and a result of file transfer by sound effect while a file is being transferred.

### BRIEF DESCRIPTION OF THE DRAWINGS

FIG. 1(A) is a front view showing a mobile apparatus (mobile phone) in an open state according to the present invention;

FIG. 1(B) is a side view showing the mobile apparatus (mobile phone) in the open state according to a present invention;

FIG. 2(A) is a front view showing the mobile apparatus (mobile phone) in a closed state according to the present invention;

FIG. 2(B) is a side view showing the mobile apparatus (mobile phone) in the closed state according to the present invention;

FIG. 3 is a block diagram of the mobile apparatus (mobile phone) according to the present invention;

FIG. 4 is a schematic view explaining a procedure when the mobile apparatus (mobile phone) according to the present invention executes a calling process together with a file transfer;

FIG. 5 is a flowchart showing the procedure when the mobile apparatus (mobile phone) according to the present invention executes the calling process together with the file transfer;

FIG. 6 is a schematic view showing a method of reproducing sound effect when the mobile apparatus (mobile phone) according to the present invention executes to a transfer of a file process; and

FIG. 7 is a flowchart showing a procedure when the mobile apparatus (mobile phone) according to the present invention executes the calling process together with the file transfer.

### DESCRIPTION OF THE PREFERRED EMBODIMENTS

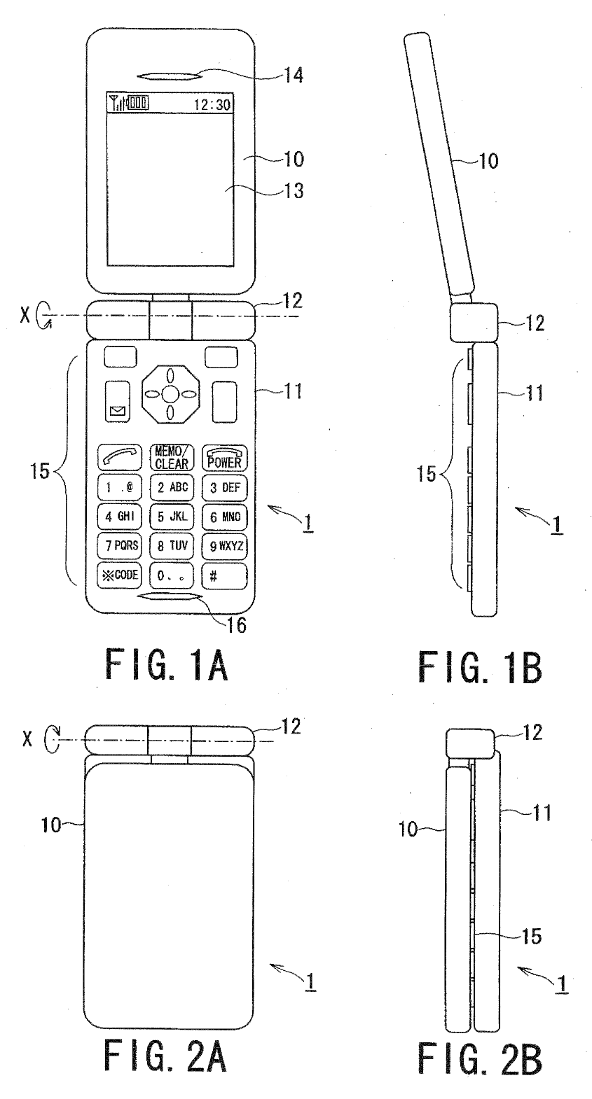

An embodiment of the mobile apparatus according to the present invention will be explained referring to the accompanying drawings. A clamshell mobile phone 1, which is composed of a plurality of cases openably and closably coupled with each other, will be explained as an example of the mobile apparatus according to the present invention. FIG. 1(A) is a front view showing the mobile phone 1 in an open state, FIG. 1(B) is a side view showing the mobile phone 1 in the open state according to the present invention, FIG. 2(A) is a front view showing the mobile phone 1 in a closed state, and FIG. 2(B) is a side view showing the mobile phone 1 in the closed state.

As shown in FIGS. 1 and 2, the mobile phone 1 is mainly composed of a rectangular plate-shaped upper case 10 and a lower case 11 having approximately the same shape as that of the upper case 10, and the upper case 10 is stacked on the lower case 11 so that they cover one surfaces thereof in the closed state. The upper case 10 is hinge coupled with the lower case 11 across a hinge 12, and the upper case 10 can turn a predetermined angle with respect to the lower case 11 in an X-direction of FIGS. 1 and 2 using the hinge 12 as the axis of turn. The mobile phone 1 is modified from the closed state to the open state or from the open state to the closed state by turning the upper case 10 with respect to the lower case 11.

A display 13 is disposed on an inner surface of the upper case 10 (surface facing the lower case 11) to display information including characters, images, and the like. The display 13 is composed of, for example, a liquid crystal display formed of a liquid crystal panel, an organic EL display formed of an organic EL (Electro-Luminescence) panel, and the like. Further, a speaker 14 is disposed to the inner surface of the upper case 10 to output audio. Although the display 13 and the speaker 14 are covered by the lower case 11 and are not exposed to the outside when the mobile phone 1 is in the closed state, they are exposed to the outside when the upper case 10 is turned with respect to the lower case 11 and modified to the open state.

Operation keys 15 composed of, for example, a power supply key for turning on and off a power supply, a call key for executing a call process, ten keys for inputting numerals and characters, a shortcut key for starting a mail function, a Web browsing function, and the like are disposed on an inner surface of the lower case 11 (surface facing the upper case 10). Further, a microphone 16 is disposed to the inner surface of the lower case 11 to collect audio. Although the operation keys 15 and the microphone 16 are covered by the upper case 10 and are not exposed to the outside when the mobile phone 1 is in the closed state, they are exposed to the outside when the upper case 10 is turned with respect to the lower case 11 and modified to the open state.

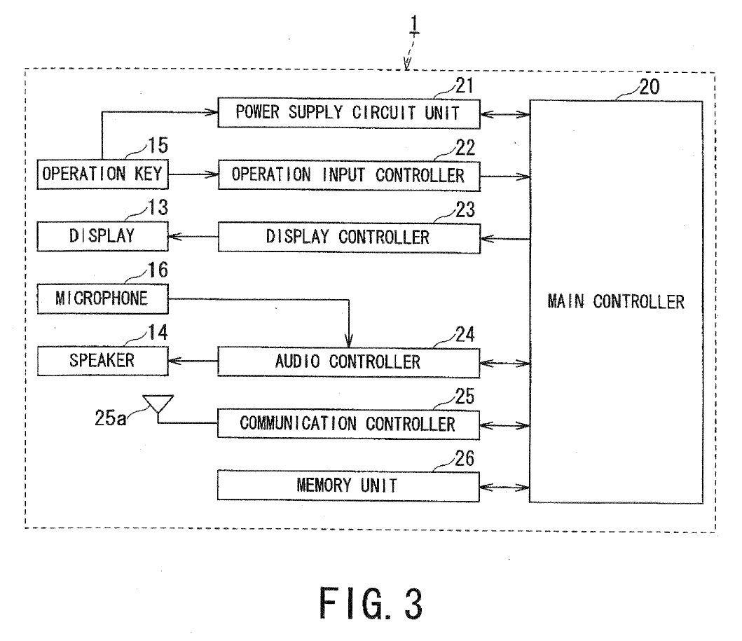

Next, a function of the mobile phone 1 will be explained using a block diagram shown in FIG. 3. As shown in FIG. 3, the mobile phone 1 is arranged such that a main controller 20, a power supply circuit unit 21, an operation input controller 22, a display controller 23, an audio controller 24, a communication controller 25, and a memory unit 26 are connected to each other through a bus so that a communication can be carried out.

The main controller 20 has a CPU (Central Processing Unit) for processing various data and executing an arithmetic operation, controls the mobile phone 1 in its entirety, and executes screen display processing, screen update processing, and other various arithmetic operation processing, control processing, and the like to be described later. The power supply circuit unit 21 turns on and off the power supply based on an input from a user through any one of the operation keys 15, and when the power supply is turned on, the power supply circuit unit 21 supplies power from a power supply source (battery and the like) to the respective units so that the mobile apparatus 1 can be operated.

The operation input controller 22 has an input interface to the operation keys 15, and when any one of the operation keys 15 is depressed, the operation input controller 22 creates a signal showing the depressed key and transmitted to the main controller 20. The display controller 23 has a display interface to the display 13 and displays a screen composed of document data, still image data, moving image data, and the like on the display 13 under the control of the main controller 20.

The audio controller 24 creates an analog audio signal from the audio collected by the microphone 16 under the control of the main controller 20 and converts the analog audio signal to a digital audio signal. When the audio controller 24 obtains a digital audio signal, it converts the digital audio signal to an analog audio signal under the control of the main controller 20 and outputs it from the speaker 14 as audio.

The communication controller 25 restores a signal received from a base station through an antenna 25a to data by subjecting the signal to spread spectrum inverse processing under the control of the main controller 20. The data is transmitted to the audio controller 24 and output from the speaker 14, transmitted to the display controller 23 and displayed on the display 13, or recorded to the memory unit 26 in response to an instruction from the main controller 20. Further, when the communication controller 25 obtains the audio data collected by the microphone 16, the data input through the operation keys 15 and the data stored to the memory unit 26 under the control of the main controller 20, it transmits the data to the base station through the antenna 25a after it subjects the data to spread spectrum processing.

The memory unit 26 is composed of ROM (Read Only Memory) for storing processing programs, data necessary to processing, and the like which are used when the main controller 20 executes the processing, a hard disc, a non-volatile memory, a database, RAM (Random Access Memory) for temporarily storing data used when the main controller 20 executes the processing, and the like. Further, it is assumed that a processing program, which is used when the main controller 20 executes transfer monitor processing to be described later, is stored to, for example, the ROM.

The mobile phone 1 has such a function that when a voice communication is performed, an outgoing side transmits contents including at least melody data to an incoming side as incoming contents and the incoming side receives the incoming contents and reproduces them in place of an existing incoming melody. A method of transmitting incoming contents when the mobile phone 1 transmits audio and causing a mobile phone on an incoming side to reproduce the incoming contents as an incoming melody has a problem in that a time zone occurs during which a user of the mobile phone 1 on an outgoing side must wait until a file transfer is completed before voice communication processing is started different from a method of using an existing incoming melody of the mobile phone on the incoming side.

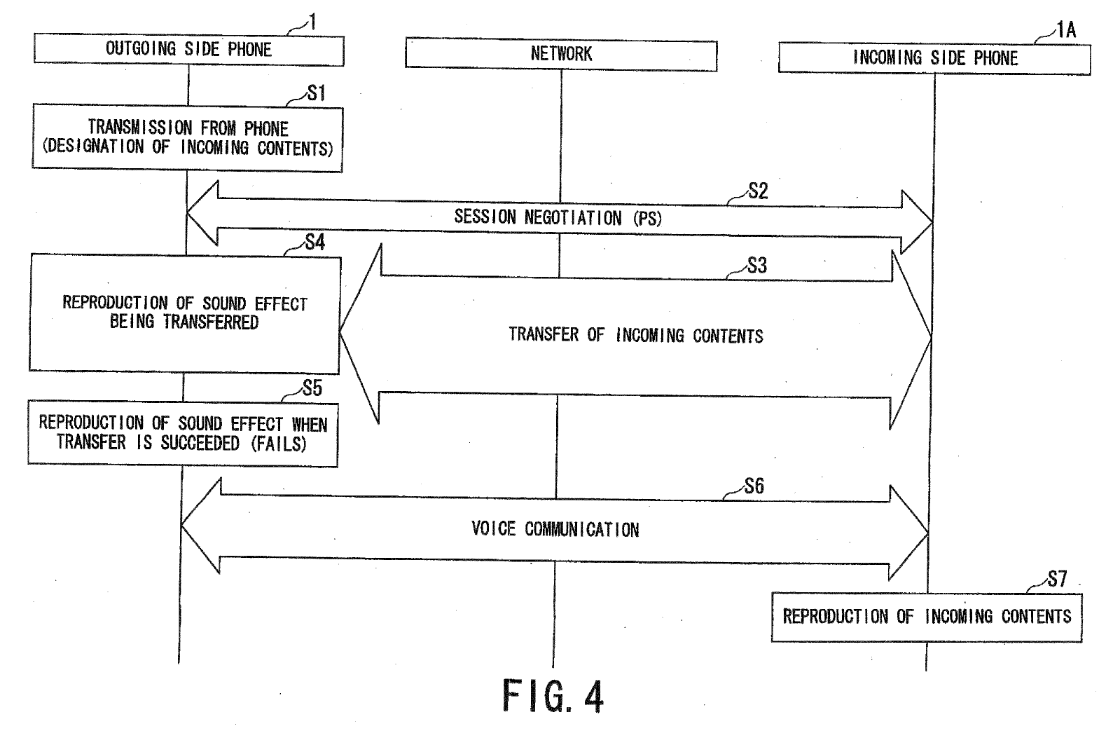

To cope with the above problem, the mobile phone 1 has a function for causing the speaker 14 to reproduce audio effect showing a progress of file transfer and audio effect showing a result of transfer of a file. FIG. 4 is a schematic view showing a procedure when the mobile phone 1 executes audio transmission processing accompanied with a transfer of an audio file.

When the mobile phone 1 transmits audio, a user of the mobile phone 1 on the outgoing side designates incoming contents such as an audio file and the like for causing a mobile phone 1A on an incoming side to reproduce the transmitted audio as an incoming melody using, for example, any one of the operation keys 15 (S1). Then, the mobile phone 1 on the outgoing side starts a communication to the mobile phone 1A on the incoming side and completes a session negotiation to the mobile phone 1A on the incoming side (S2). The mobile phone 1 on the outgoing side transmits the designated incoming contents to the mobile phone 1A on the incoming side making use of a packet service (S3).

The mobile phone 1 on the outgoing side displays a progress bar on the screen of the mobile phone 1 on the outgoing side to show the progress of a file transfer while the incoming contents are being transmitted and at the same time a tone is sounded from the speaker 14 to show a state in which the file is being transferred or the progress of a file transfer (S4). Since a state of an ordinary voice communication can be simulated by approximating a sound of tone at the time to a sound of tone of the voice communication to be sounded thereafter, the audio file can be transferred without giving uncomfortable feeling to the user. A pitch and a tempo of tone can be changed according to a change of the progress of the transfer of a file. As a result, the user of the mobile phone 1 on the outgoing side can find a file transfer state through the sense of hearing. When the transfer of a file is finished, whether or not the file is succeedingly transferred is notified to the user by sounding a different type of sound effect from the speaker 14 (S5).

Thereafter, the mobile phone 1 on the outgoing side transmits ordinary audio to the mobile phone 1A on the incoming side (S6). When the mobile phone 1A on the incoming side succeedingly receives the incoming contents by receiving the transmitted ordinary audio, it reproduces the received incoming contents as the incoming melody (S7).

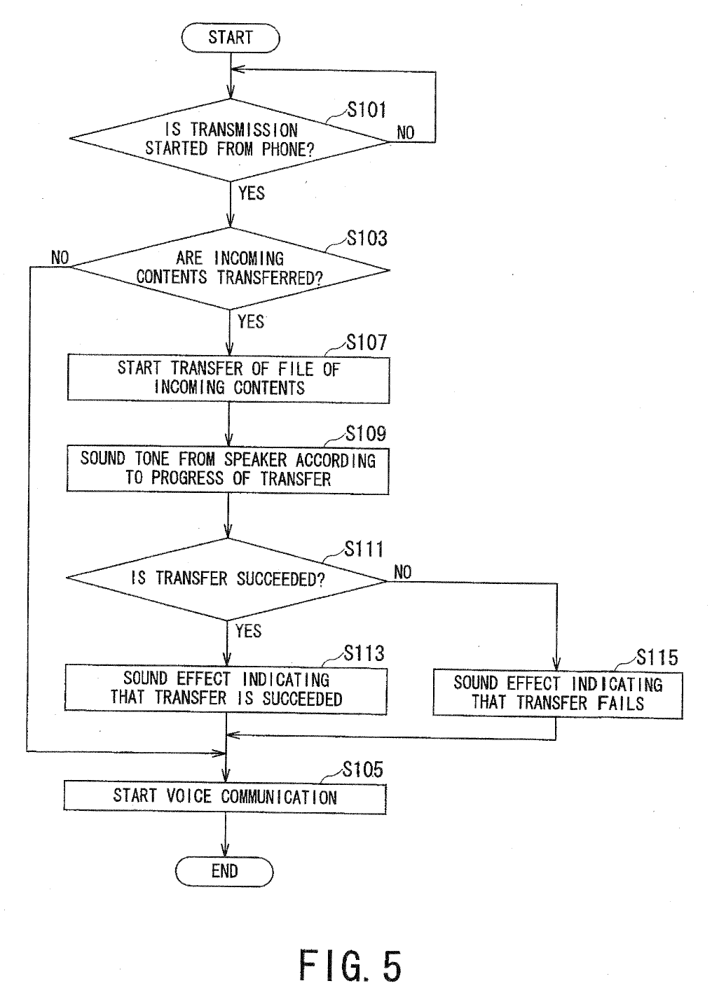

A procedure by which the mobile phone executes audio transmission processing together with the file transfer will be explained based on a flowchart shown in FIG. 5. Although an example, in which the mobile phone 1 on the outgoing side transfers the audio file as the incoming contents to the mobile phone 1A on the incoming side, is explained here, it is sufficient that the contents to be transmitted include at least melody data, and the contents may be a video including moving image data. In the following description, a term “step” affixed to a step number is omitted, and, for example, “step S101” is shown as “S101”.

First, the main controller 20 determines whether or not phone transmission is started (S101). When the phone transmission is not started (S101: No), the main controller 20 waits as it is. When the phone transmission is started (S101: Yes), the main controller 20 determines whether or not the incoming contents are transmitted (S103).

That is, when the phone transmission is executed, the incoming melody is reproduced depending on whether the incoming melody is reproduced according to the setting of a mobile phone of an opponent or the audio file is transferred from the mobile phone 1 on the transmission side to the mobile phone 1A on the incoming side and the audio file received by the mobile phone 1A on the incoming side is reproduced. When the user desires to transfer the audio file to a phone call opponent, he or she selects an audio file to be transferred from a plurality of audio files through any one of the operation keys 15 before a phone call is started.

When the incoming contents are not transmitted (S103: No), the main controller 20 starts ordinary voice communication processing (S105). When the incoming contents are transmitted (S103: Yes), the main controller 20 starts to transfer the incoming contents (S107). At the time, the main controller 20 transfers an audio file selected by the user and a previously designated audio file.

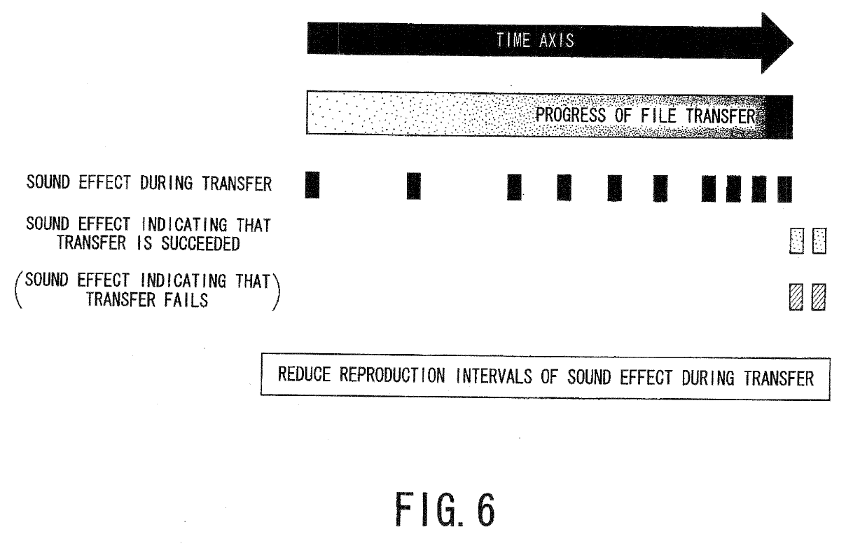

Further, the main controller 20 causes the speaker 14 to sound sound effect (tone) according to the progress of a file transfer (S109). At the time, it is preferable that sound effect, which indicates that the audio file is being transferred, start to be sounded at, for example, the start of transfer of the audio file and the sound effect be more or less frequently sounded, that is, the tempo of the sound effect be increased (or decreased) as a transfer of a file time passes as shown in FIG. 6. Otherwise, when the audio file starts to be transferred, the sound effect, which indicates that the audio file is being transferred, may be sounded in a small volume (or in a large volume) and the volume thereof may be increased (or decreased) as the transfer of a file time passes. Otherwise, when the audio file starts to be transferred, the sound effect, which indicates that the audio file is being transferred, may be sounded in a low pitch (or in a high pitch) and the pitch thereof may be increased as the transfer of a file time passes.

The main controller 20 determines whether or not the transfer of a file is succeeded (S111). For example, when the negotiation fails or when the mobile phone 1 on the outgoing side or the mobile phone 1A on the incoming side is in a weak radio wave state, since the transfer of a file fails, the audio file is not transferred to the mobile phone 1A on the incoming side. Accordingly, the mobile phone 1A on the incoming side can not use the audio file as the incoming melody.

When the transfer of a file is succeeded (S111: Yes), the main controller 20 stops sounding the sound effect indicating that the audio file is being transferred and sounds sound effect indicating that the transfer of a file is succeeded (S113). The sound effect at the time is preferably different from the sound effect indicating that the audio file is being transferred.

When the transfer of a file fails (S111: No), the main controller 20 stops sounding the sound effect indicating that the audio file is being transferred and sounds sound effect indicating that the transfer of a file fails (S115). The sound effect at the time is preferably different from the sound effect indicating that the audio file is being transferred.

Then, the main controller 20 starts the voice communication to a phone call opponent by transmitting a voice thereto (S105). At the time, when the transfer of a file is succeeded at step 111, the mobile phone 1A on the incoming side reproduces the audio file transferred at steps S105 to S111 as the incoming melody.

When the incoming contents (for example, the audio file), which are reproduced by the mobile phone 1A on the incoming side as incoming audio, are transmitted at the time the voice is transmitted to the mobile phone 1A on the incoming side as described above, the mobile phone 1 on the outgoing side notifies the user of the mobile phone 1A on the incoming side of the progress information of the transfer by sounding the sound effect indicating the progress of transmission while the incoming contents are being transmitted. With this operation, the user of the mobile phone 1A on the incoming side can confirm the progress of transmission in a state that his or her ear is put on the mobile phone 1.

Further, when the incoming contents (for example, the audio file), which are reproduced by the mobile phone 1A on the incoming side as the incoming audio, are transmitted at the time the voice is transmitted to the mobile phone 1A on the incoming side, the mobile phone 1 on the outgoing side notifies the user of the mobile phone 1A on the incoming side of a result of transfer by audio by sounding sound effect indicating the result of transfer (whether the transmission is succeeded or not) on the completion of transmission of the incoming contents. With this operation, the user of the mobile phone 1 on the outgoing side can confirm the result of transfer in a state that his or her ear is put on the mobile phone 1.

When the mobile phone 1 sounds the sound effect indicating that the file is being transferred or the sound effect indicating that the transfer of a file is succeeded, it may reproduce an audio file, which is previously designated by the user of the mobile phone 1 and stored to the memory unit 26 and an audio transfer of a filered to the phone call opponent.

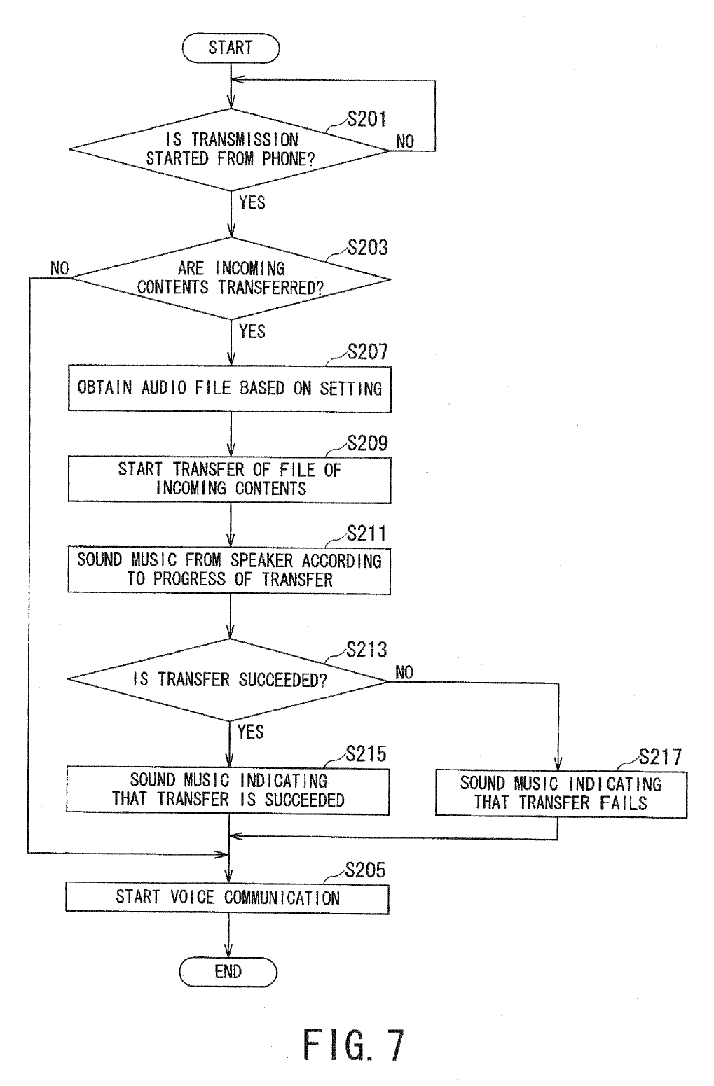

A procedure by which the mobile phone 1 executes audio transmission processing together with the file transfer at the time will be explained based on a flowchart shown in FIG. 7.

Note that it is assumed, for example, that the audio file indicating that the file is being transferred, the audio file indicating that the transfer of a file is succeeded, and the audio file indicating that the transfer of a file fails are previously set by previously designating them from a plurality of audio files stored to the memory unit 26 by the user through any one of the operation keys 15.

First, the main controller 20 determines whether or not phone transmission is started (S201). When the phone transmission is not started (S201: No), the main controller 20 waits as it is. When the phone transmission is started (S201: Yes), the main controller 20 determines whether or not the incoming contents are transmitted (S203).

When the incoming contents are not transmitted (S203: No), the main controller 20 starts ordinary voice communication processing (S205). When the incoming contents are transmitted (S203: Yes), the main controller 20 obtains the audio file indicating that the file is being transferred, the audio file indicating that the transfer of a file is succeeded, and the audio file indicating that the transfer of a file fails from the memory unit 26 based on setting (S207).

Then, the main controller 20 starts to transfer the incoming contents (S209) At the time, the main controller 20 transfers an audio file selected by the user and a previously designated audio file. Further, the main controller 20 reproduces the audio file which is obtained from the speaker 14 at step S207 and indicates that the file is being transferred according to the progress of a file transfer (S211). At the time, it is preferable that sound effect, which indicates that the audio file is being transferred, start to be sounded at, for example, the start of transfer of the audio file and the sound effect is more or less frequently sounded, that is, the tempo of the sound effect be increased (or decreased) as a file transfer time passes. Otherwise, when the audio file starts to be transferred, the sound effect, which indicates that the audio file is being transferred, may be sounded in a small volume (or in a large volume) and the volume thereof may be increased (or decreased) as the transfer of a file time passes.

The main controller 20 determines whether or not the transfer of a file is succeeded (S213).

When the transfer of a file is succeeded (S213: Yes), the main controller 20 stops reproducing the sound file indicating that the audio file is being transferred and reproduces the sound file indicating that the transfer of a file is succeeded (S215).

When the file transfer fails (S213: No), the main controller 20 stops reproducing the sound effect indicating that the audio file is being transferred and reproduces the sound file indicating that the transfer of a file obtained at step 207 fails (S217).

Then, the main controller 20 starts the voice communication to a phone call opponent by transmitting a voice thereto (S205). At the time, when the transfer of a file is succeeded at step 213, the mobile phone 1A on the incoming side reproduces the audio file transferred at steps S207 to S213 as an incoming melody.

When the incoming contents (for example, the audio file), which are reproduced as incoming audio by the mobile phone 1A on the incoming side, are transmitted at the time the voice is transmitted to the mobile phone 1A on the incoming side as described above, the mobile phone 1 on the outgoing side notifies the user of the mobile phone 1A on the incoming side of the progress information of the transfer by reproducing the audio file indicating the progress of transmission while the incoming contents are being transmitted. With this operation, the user of the mobile phone 1 on the outgoing side can confirm the progress of transmission in a state that his or her ear is put on the mobile phone 1.

Further, when the incoming contents (for example, the audio file), which are reproduced by the mobile phone 1A on the incoming side as the incoming audio, are transmitted at the time the voice is transmitted to the mobile phone 1A on the incoming side, the mobile phone 1 on the outgoing side notifies the user of a result of transfer by audio by reproducing the audio file indicating the result of transfer (whether the transmission is succeeded or not) on the completion of transmission of the incoming contents. With this operation, the user of the mobile phone 1 on the outgoing side can confirm the result of transfer in a state that his or her ear is put on the mobile phone 1.

Note that since an audio file, which is actually transferred to the mobile phone 1A on the incoming side, is reproduced as the audio file indicating that the file is being transferred, the user can confirm whether or not the audio file to be transferred is correctly selected by his or her ear. At the time, when the contents to be transferred include moving image data, the moving image data is preferably reproduced.

Further, the mobile phone 1 may be vibrated in parallel with or in place of generating the sound effect indicating the result transfer. In this case, the progress of transfer can be notified to the user by changing the tempo and the intensity of the vibration according to the progress of transfer. With this operation, the user of the mobile phone 1 on the outgoing side can confirm the progress of transfer of the incoming contents in a state that his or her ear is put on the mobile phone 1.

Further, when the user of the mobile phone 1 on the outgoing side can designate any one of the audio file indicating that the file is being transferred, the audio file indicating that the transfer of a file is succeeded, and the audio file indicating that the transfer of a file fails, since the audio file designated by the user is reproduced in the mobile phone 1A on the incoming side while the incoming contents (for example, audio file) are transmitted thereto, the user can comfortably spend a waiting time.

Since the mobile apparatuses (mobile phones 1 and 1A) of the present invention have such a function that the mobile phone 1 on the outgoing side transmits multimedia contents as the incoming contents to the mobile phone 1A on the incoming side, the mobile phone 1A on the incoming side reproduce the incoming contents as the incoming melody, and the user of the mobile phone 1 can find a file transfer state and the like by the sense of hearing without paying attention to a screen because the progress of the file being transferred and a result of transfer of the file are indicated by the audio effect.

The present invention has been explained as to the mobile phone, it is not limited thereto and may be any optional mobile terminals such as PHS (Personal Handy Phone System), PDA (Personal Digital Assistants), compact TV equipment, a digital camera, a video camera, mobile audio equipment, mobile video equipment, and the like as long as they have a communication function and a data communication function

What is claimed is:

1. A mobile apparatus having a transmission unit configured to transmit contents including at least melody data to a communication terminal for reproducing the contents as an incoming melody comprising:
a first sounding unit configured to sound sound effect while the contents are being transmitted by the transmission unit;
a second sounding unit configured to sound, when transmission of the contents by the transmission unit is finished, sound effect indicating whether the transmission is succeeded or fails; and
a calling unit configured to call an opponent to which the contents are transmitted based on the completion of transmission of the contents by the transmission unit.

2. The mobile apparatus according to claim 1 comprising:
a reception unit configured to receive contents transmitted by the transmission unit;
an incoming unit configured to accept a call from the calling unit; and
a reproduction unit configured to reproduce, when the reception unit accepts the transmission, the contents received by the reception unit.

3. The mobile apparatus according to claim 1, wherein the first sounding unit changes the tempo of the sound effect according to the progress of transmission by the transmission unit.

4. The mobile apparatus according to claim 1, wherein the first sounding unit changes the volume of the sound effect according to the progress of transmission by the transmission unit.

5. The mobile apparatus according to claim 1, wherein the first sounding unit changes the pitch of the sound effect according to the progress of transmission by the transmission unit.

6. The mobile apparatus according to claim 1, wherein the first sounding unit sounds sound effect by reproducing an audio file.

7. The mobile apparatus according to claim 1, wherein the first sounding unit sounds sound effect by reproducing the contents transmitted by the transmission unit.

8. The mobile apparatus according to claim 1, wherein when the contents transmitted by the transmission unit includes moving image data, the first sounding unit sounds sound effect by reproducing the moving image data.

9. A mobile apparatus having a transmission unit configured to transmit contents including at least melody data to a communication terminal for reproducing the contents as an incoming melody comprising:
a first sounding unit configured to reproduce the contents transmitted by the transmission unit while the contents are being transmitted by the transmission unit;
a second sounding unit configured to sound, when transmission of contents by the transmission unit is finished, sound effect indicating whether the transmission is succeeded or fails; and
a calling unit configured to call an opponent to which the contents are transmitted based on the completion of transmission of the contents by the transmission unit.

10. A calling method of a mobile apparatus having a transmission unit configured to transmit contents including at least melody data to a communication terminal for reproducing the contents as an incoming melody comprising:
a first sounding step of sounding sound effect while the contents are being transmitted by the transmission unit;
a second sounding step of sounding, when transmission of the contents by the transmission unit is finished, sound effect indicating whether the transmission is succeeded or fails; and
a calling step of calling an opponent to which the contents are transmitted based on the completion of transmission of the contents by the transmission unit.

11. The calling method of the mobile apparatus according to claim 10 comprising:
a reception step of receiving contents transmitted by the transmission unit;
an incoming step of accepting a call in the calling step; and
a reproduction step of reproducing, when the contents is accepted at the reception step, the contents received at the reception step.

12. The calling method of the mobile apparatus according to claim 10, wherein the tempo of the sound effect is changed according to the progress of transmission by the transmission unit at the first sounding step.

13. The calling method of the mobile apparatus according to claim 10, wherein the volume of the sound effect is changed according to the progress of transmission by the transmission unit at the first sounding step.

14. The calling method of the mobile apparatus according to claim 10, wherein the pitch of the sound effect is changed according to the progress of transmission by the transmission unit at the first sounding step.

15. The calling method of the mobile apparatus according to claim 10, wherein sound effect is sounded by reproducing an audio file at the first sounding step.

16. The calling method of the mobile apparatus according to claim 10, wherein sound effect is sounded by reproducing the contents transmitted by the transmission unit at the first sounding step.

17. The calling method of the mobile apparatus according to claim 10, wherein when the contents transmitted by the transmission unit includes moving image data, sound effect is sounded by reproducing the moving image data at the first sounding step.
